(19) United States
(12) Patent Application Publication
(10) Pub. No.: US 2011/0078593 A1
(43) Pub. Date: Mar. 31, 2011

(54) WEB BROWSER TRANSMISSION SERVER AND METHOD OF CONTROLLING OPERATION OF SAME

(75) Inventor: Yuko MATSUI, Ashigarakami-gun (JP)

(73) Assignee: FUJIFILM Corporation, Tokyo (JP)

(21) Appl. No.: 12/891,611

(22) Filed: Sep. 27, 2010

(30) Foreign Application Priority Data
Sep. 28, 2009 (JP) 2009-222110

(51) Int. Cl. G06F 3/048

(52) U.S. Cl. 715/760

(57) ABSTRACT

A first browser has been installed in a mobile telephone. When the mobile telephone requests a relay server for a second browser, the relay server selects a second browser corresponding to the model of the mobile telephone, the second browser being such that its keypad button operations are identical with those of the first web browser. The second browser thus selected in conformity with the model of mobile telephone is transmitted from the relay server to the mobile telephone. When the second browser is operated on the mobile telephone, it is operated in the same manner as the first browser. As a result, the user finds it simple to operate the second browser.

### BACKGROUND OF THE INVENTION

1. Field of the Invention

This invention relates to a web browser transmission server and to a method of controlling the operation thereof.

2. Description of the Related Art

Thin client systems have become the focus of attention owing to great strides in communication technology and improvements in security. For example, there are techniques whereby a server is made to run application software and an operating system, etc., and a client terminal is allowed to access the server so that the client terminal can be operated just as if it were running the application software and operating system without actually doing so (see the specifications of Japanese Patent Application Laid-Open Nos. 2003-323402 and 2003-330728), and a technique whereby a conversion can be made to a landscape-type display in a case where a document having a large number of characters is presented on a portrait-type display screen of a client terminal (see the specification of Japanese Patent Application Laid-Open No. 9-237074).

Further, in a case where a web page is viewed on a mobile telephone, the functions that have been assigned to the keypad differ for every model of mobile telephone. For example, although a function for returning to the previous page may be assigned to a CLEAR button on a certain mobile telephone, the CLEAR button on another mobile telephone may be assigned a function for quitting a web browser. The user must therefore ascertain keypad functions that differ from one model of mobile telephone to the next.

### SUMMARY OF THE INVENTION

An object of the present invention is to so arrange that in a case where a second web browser that differs from a first web browser that has been installed in a mobile telephone is installed in this mobile telephone, the functions assigned to the keypad when the first web browser runs are the same even when the second web browser is run.

The present invention provides a web browser transmission server comprising: a model data receiving device (model data receiving means) for receiving model data, which specifies the model of a mobile telephone, transmitted from the mobile telephone in which a first web browser has been installed; a web browser reading device (web browser reading means) for reading a second web browser, which corresponds to the model specified by the model data received by the model data receiving device, from a storage device in which a number of second web browsers have been stored in correspondence with mobile-telephone models, these second web browsers being such that commands thereof assigned to the keypad of the mobile telephone will be identical with commands of the first web browser that have been assigned to the keypad of the mobile telephone; and a web browser transmitting device (web browser transmitting means) for transmitting the second web browser, which has been read by the web browser reading device, to the mobile telephone that transmitted the model data.

The present invention also provides an operation control method suited to the above-described web browser transmission server. Specifically, the present invention provides a method of controlling operation of a web browser transmission server comprising the steps of: specifying the model of a mobile telephone transmitted from a mobile telephone in which a first web browser has been installed; reading a second web browser, which corresponds to the model specified by the model data received, from a storage device in which a number of second web browsers have been stored in correspondence with mobile-telephone models, these second web browsers being such that commands thereof assigned to the keypad of the mobile telephone will be identical with commands of the first web browser that have been assigned to the keypad of the mobile telephone; and transmitting the read second web browser to the mobile telephone that transmitted the model data.

In accordance with the present invention, a number of second web browsers have been stored in a storage device in association with models of mobile telephones. The second web browsers are such that their commands, which are identical with those of the first web browser that have been assigned to the mobile-telephone keypad, will be assigned to the mobile-telephone keypad. When model data specifying the model of a mobile telephone is transmitted from the mobile telephone, the model data is received by a web browser transmission server. A second web browser corresponding to the mobile telephone specified by the received model data is read from the storage device. The read second web browser is transmitted from the web browser transmission server to the mobile telephone. The second web browser received by the mobile telephone is such that it has commands identical with those that have been assigned to the mobile-telephone keypad in order to operate the first web browser that has been installed in the mobile telephone. This means that the second web browser is operated in the same manner as the first web browser and, hence, the user need not learn a new method of operation.

The web browser transmission server further comprises: a web page request receiving device (web page request receiving means) for receiving a web page request transmitted from a mobile telephone; a web page request transmitting device (web page request transmitting means) for transmitting a web page request, which has been received by the web page request receiving device, to a web page server storing web page content representing a web page requested by this web page request; a web page content receiving device (web page content receiving means) for receiving web page content transmitted from the web page server in response to transmission of the web page request to the web server by the web page request transmitting device; a first image file generating device (first image file generating means) for generating an image file representing, as an image, the web page represented by the web page content received by the web page content receiving device; a user interface metadata generating device (user interface metadata generating means) for generating user interface metadata from user interface information, which is included in the web page content received by the web page content receiving device and represents a user interface area that accepts an input or check from a user on the web page, the user interface metadata representing a coordinate position of the user interface area on the web page as well as the details of the input or check in the user interface area; a first image file/user interface metadata transmitting device (first image file/user interface data transmitting means) for transmitting the image file generated by the first image file generating device and the user interface metadata generated by the user interface metadata generating device to the mobile telephone that transmitted the web page request; a user interface metadata receiving device (user interface metadata receiving means), responsive to transmission by the first image file/user interface metadata transmitting device of the image file and user interface metadata to the mobile telephone that transmitted the web page request, for receiving the user interface metadata transmitted from the mobile telephone; a second image file generating device (second image file generating means) for generating an image file representing, as an image, a web page having contents in which the user interface area is represented by the user interface metadata that has been received by the user interface metadata receiving device; and a second image file/user interface metadata transmitting device (second image file/user interface metadata transmitting means) for transmitting the user interface metadata received by the user interface metadata receiving device and the image file generated by the second image file generating device to the mobile telephone that transmitted the user interface metadata.

In this case, by way of example, the second web browser displays an image, which is represented by the image files that have been transmitted from the first image file/user interface metadata transmitting device and from the second image file/user interface metadata transmitting device, on a display screen of the mobile telephone, rewrites the user interface metadata, which has been transmitted from the first image file/user interface metadata transmitting device and from the second image file/user interface metadata transmitting device, in accordance with an input or check from the keypad of the mobile telephone, and transmits the rewritten user interface metadata to the web browser transmission server.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates the external appearance of a mobile telephone;

FIG. 2 is an example of a button/function table;

FIG. 3 illustrates a mobile telephone and a personal computer;

FIG. 4 illustrates an overview of a web page viewing system;

FIG. 5 is a block diagram illustrating the electrical configuration of a mobile telephone;

FIG. 6 is a block diagram illustrating the electrical configuration of a relay server;

FIG. 7 is an example of a mobile telephone model name/browser number table;

FIG. 8 is an example of a button/function table;

FIG. 9 is a block diagram illustrating the electrical configuration of a web server;

FIGS. 10 to 12 are flowcharts illustrating processing executed by a web page viewing system;

FIG. 13 is an example of a web page;

FIG. 14 is an example of an HTML document;

FIG. 15 is an example of a web page image;

FIG. 16 is an example of user interface metadata;

FIG. 17 is a flowchart illustrating processing executed by a mobile telephone;

FIGS. 18 to 21d are examples of display screens on a mobile telephone;

FIGS. 22 to 24 are examples of user interface metadata; and

FIG. 25 is a flowchart illustrating processing executed by a mobile telephone and relay server according to a modification.

### DESCRIPTION OF THE PREFERRED EMBODIMENT

A preferred embodiment of the present invention will be described with reference to the drawings.

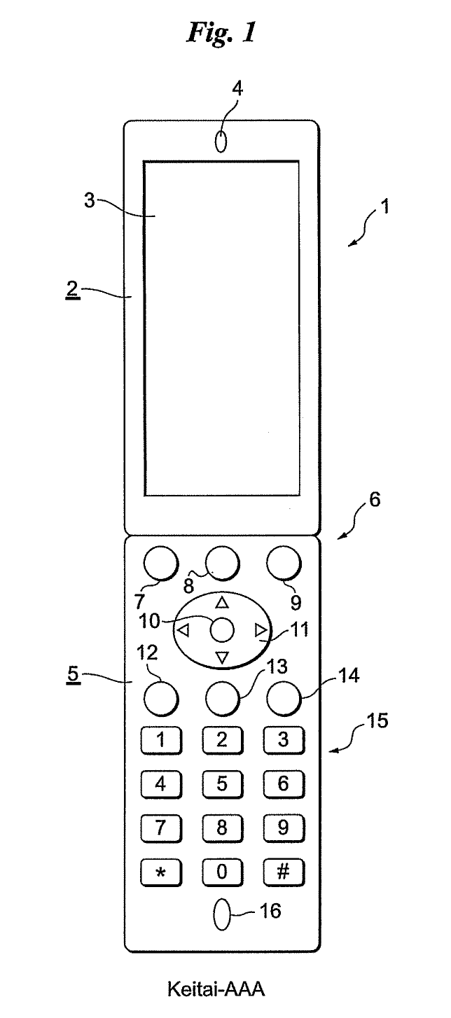

FIG. 1 is a front view of a mobile telephone 1.

Here “Keitai-AAA” is the model of the mobile telephone 1. The mobile telephone 1, which is of the clam-shall type (although it need necessarily be of the clam-shell type), has a first-half body 2 and a second-half body 5.

The upper portion of the first-half body 2 is provided with a speaker 4, and a display screen 3 is formed over the entire surface of the first-half body 2.

The second-half body 5 is provided with a multi-button keypad 6. The multi-button keypad 6 includes a telephone directory button 7, a setting button 8, a menu button 9, an enter button 10, an annular button 11 on which up, down, left and right arrows have been formed, a call button 12, a clear button 13, a power source on/off button 14 and buttons 15 on which numerals 0 to 9, an asterisk symbol and a sharp symbol have been formed. A microphone 16 is formed below the keypad 6.

A browser (first browser) has been installed in the mobile telephone 1. Either browser of a browser (first browser) that makes it possible to view a web page for a mobile telephone or a browser (first browser) that makes it possible to view a web page for a personal computer has been installed in the mobile telephone 1, but no distinction is made between them.

Owing to the fact that the browser has been installed in the mobile telephone 1, a web page can be displayed on the display screen 3. If the browser that has been installed in the mobile telephone 1 is utilized, the functions of the browser will have been assigned to the buttons of the keypad 6 of the mobile telephone 1 in conformity with the browser. The button functions that have been assigned to the browser differ for every model of the mobile telephone 1; if the model of the mobile telephone 1 differs, then the functions assigned to the buttons also differ.

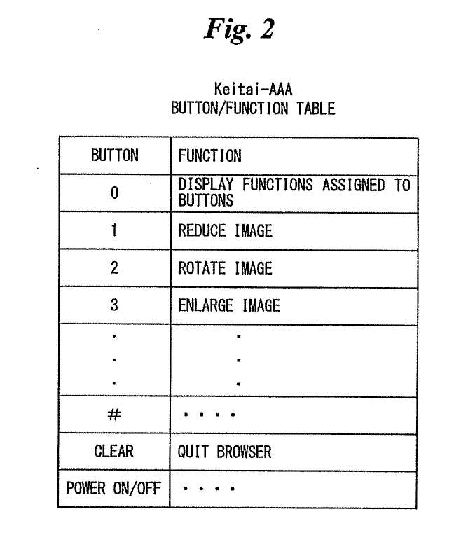

FIG. 2 is a button/function table illustrating the relationship between buttons and button functions that have been assigned to the model “Keitai-AAA” shown in FIG. 1.

The button/function table has been stored in a memory of the mobile telephone 1. If a browser that has been installed in the mobile telephone 1 has been launched, the mobile telephone 1 (first browser) is controlled in such a manner that processing based upon a function conforming to a pressed button is executed.

If the button whose numeral is “0” is pressed on the mobile telephone 1 of model “Keitai-AAA”, the functions assigned to the buttons are displayed on the mobile telephone 1. The image of the web browser being displayed by the browser is reduced in size if the button whose numeral is “1” is pressed, and the image of the web browser being displayed by the browser is rotated through a prescribed angle if the button whose numeral is “2” is pressed. Similarly, with regard to the other buttons, the functions peculiar to the model “Keitai-AAA” have been assigned to these buttons.

This embodiment is such that in a case where a second browser is to be installed which is different from the browser (the first browser) that has already been installed in the mobile telephone 1, second browsers are prepared in advance for every model of the mobile telephone 1, wherein the second browsers are such that their functions assigned to the keypad buttons will be identical with the functions that were assigned to the keypad buttons at launching of the first browser already installed in the mobile telephone 1. In a case where the second browser is installed in the mobile telephone 1, the second browser that conforms to the model of the mobile telephone 1 is selected. Even if the second browser is operated, button operation is the same as that in the case where the first browser is operated.

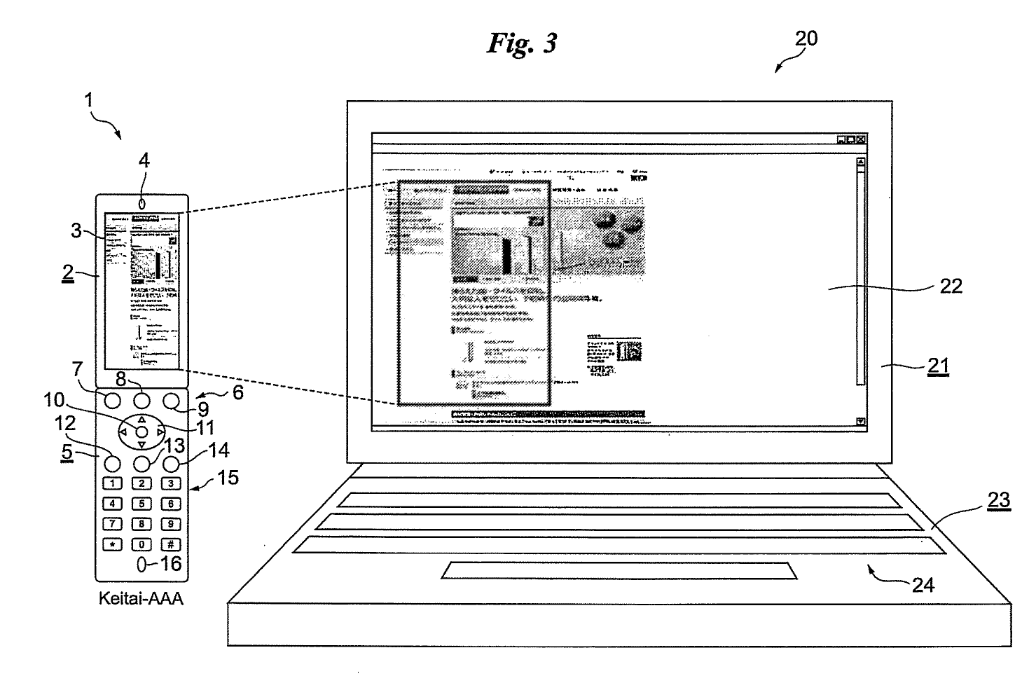

FIG. 3 illustrates the mobile telephone 1 and a personal computer 20.

The personal computer 20 includes a display section 21 and a keyboard section 23 that are freely foldable. A keyboard 24 has been formed over substantially the entire surface of the keyboard section 23.

If a website is accessed using the personal computer 20, a web page is displayed on a display screen 22. Similarly, if a website is accessed using the mobile telephone 1, a web page is displayed on the display screen 3 of the mobile telephone 1.

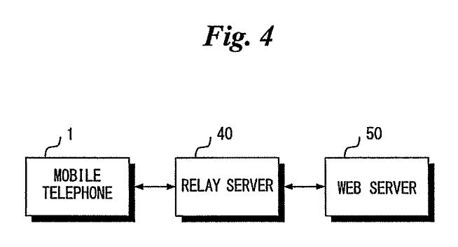

FIG. 4 illustrates an overview of a web page viewing system.

The web page viewing system includes the mobile telephone 1, which is used by a user, and a web server 50. The web page viewing system further includes a relay server 40 (web browser transmission server) 40 for relaying communication between the mobile telephone 1 and the web server 50. The mobile telephone 1 and relay server 40, as well as the relay server 40 and web server 50, can communicate via the Internet.

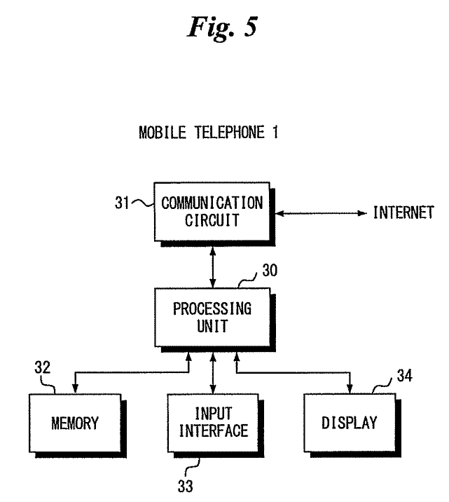

FIG. 5 is a block diagram illustrating the electrical configuration of the mobile telephone 1.

The overall operation of the mobile telephone 1 is controlled by a processing unit 30.

The mobile telephone 1 includes a communication circuit 31 for communicating with the relay server 40 via the Internet. The mobile telephone 1 further includes a memory 32 storing the first browser, other programs and data, an input interface 33 for applying commands from the keypad 6 to the processing unit 30, and a display unit 34. Although the mobile telephone 1 also has a conversation function, the conversation-related circuitry is not shown.

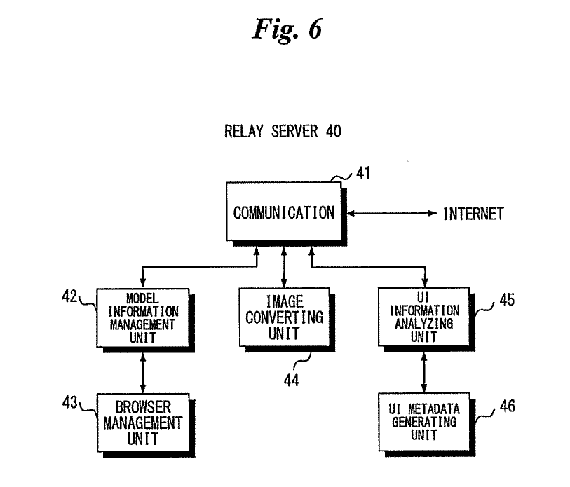

FIG. 6 is a block diagram illustrating the electrical configuration of the relay server 40.

The relay server 40 includes a communication circuit 41 for communicating with the mobile telephone 1 and the web server 50 via the Internet.

The relay server 40 includes a model information management unit 42 and a browser management unit 43.

Second browsers, whose button operation is identical with that of the first browser that has been installed in the mobile telephone 1, as mentioned above, have been stored for every model of mobile telephone 1 in the browser management unit 43. A mobile telephone model name/browser number table, which specifies second browsers corresponding to every model of mobile telephone 1, has been stored in the model information management unit 42.

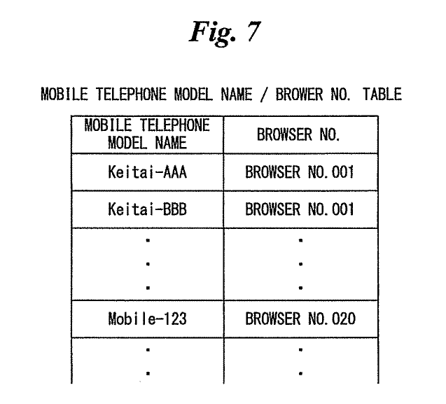

FIG. 7 illustrates an example of the mobile telephone model name/browser number table.

Browser numbers specifying second browsers whose button operation is identical with that of the first browser that has been installed in the mobile telephone 1 correspond to the mobile telephone 1, as mentioned above. Although a mobile telephone 1 of model “Keitai-AAA” and a mobile telephone 1 of model “Keitai-BBB” are of different models, the browser number “browser 001” is the same. Therefore, a second browser specified by the browser number “browser 001” is used for the mobile telephone 1 of model “Keitai-AAA” and for the mobile telephone 1 of model “Keitai-BBB”.

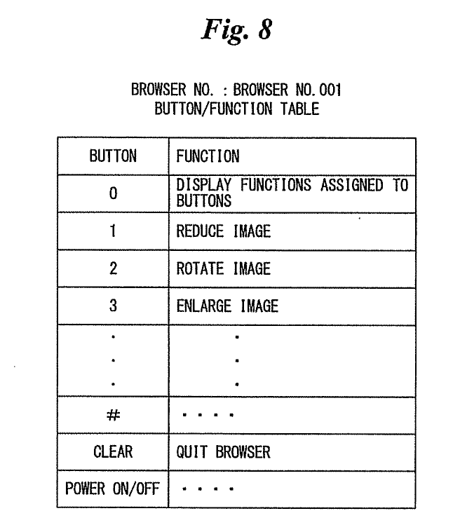

FIG. 8 is an example of a button/function table of browser number 001.

The browser number 001 specifies the browser that corresponds to the mobile telephone 1 of model “Keitai-AAA”, as mentioned above. The functions that are assigned to the buttons of the mobile telephone 1 of model “Keitai-AAA” in an instance where the second browser specified by the browser number 001 is launched are the same as the functions that have been assigned to the buttons of the mobile telephone 1 in a case where the first browser that has been installed in the mobile telephone 1 of model “Keitai-AAA” is launched. The user of the mobile telephone 1 will be capable of operating the second browser by a button operation identical with that of the first browser that has been installed in the mobile telephone 1. Such a button/function table has been stored for every second browser.

A second browser whose button operation is identical with that of the first browser that has been installed in the mobile telephone 1 is selected in accordance with the model of the mobile telephone 1 and is installed in the mobile telephone 1. The button/function table shown in FIG. 8 is included in the second browser and the second browser runs in accordance with operation of the buttons.

With reference again to FIG. 6, the relay server 40 includes an image converting unit 44. On the basis of web page content (a web page content file) that has been transmitted from the web server 50 via the communication circuit 41, the image converting unit 44 generates an image file in which the web page displayed by the web page content is represented as one frame of an image. Although the image file is generated at a predetermined resolution, the image converting unit 44 may generate an image file representing an image having a resolution that conforms to the contents of the web page content file and the resolution of the display screen of mobile telephone 1.

The relay server 40 further includes a UI (user interface) information analyzing unit 45 and a UI metadata generating unit 46. The UI information analyzing unit 45 extracts UI information contained in the web content file. The UI information represents a user interface area, such as an input area or radio button on the web page, for accepting an input or check from the user. The UI metadata generating unit 46 generates UI metadata representing the coordinate position of the user interface area on the web page and the contents of the input or check in the user interface area.

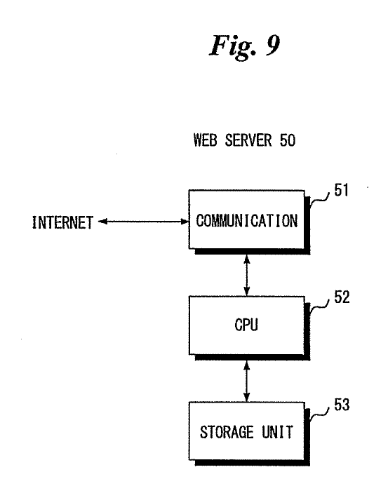

FIG. 9 is a block diagram illustrating the electrical configuration of the web server 50.

The overall operation of the web server 50 is controlled by a CPU 52.

The web server 50 also includes a communication device 51 for communicating with the relay server 40 via the Internet. The web server 50 further includes a storage unit 53 for storing a number of web content files for displaying a number of web pages. A web content file conforming to a web content request transmitted from the relay server 40 is read out of the storage unit 53. The web content file read out is transmitted to the relay server 40 by the communication device 51.

In the above-described embodiment, only one mobile telephone 1 is illustrated. However, a number of mobile telephones 1 capable of communicating with the relay server 40 exist and each communicates with the relay server 40 individually. Further, a number of the web servers 50 also exist and the relay server 40 is capable of communicating with each of the web servers 50. Regardless of which one of the mobile telephones 1 accesses which web server 50, communication is carried out via the relay server 40.

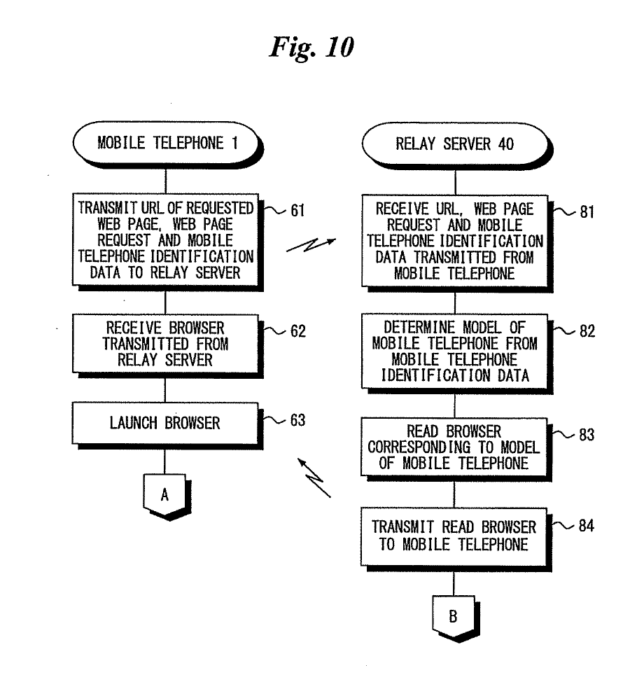

FIGS. 10 to 12 are flowcharts illustrating processing executed by the web page viewing system.

It will be assumed that the first browser has been installed in the mobile telephone 1 but that the second browser has not been installed.

The user launches the first browser and, using the keypad 16 of the mobile telephone 1, inputs the URL of the web page desired to be viewed. Rather than inputting the character string of the URL directly, the user may select the URL from among URLs that have been stored in the memory 32 of the mobile telephone 1. If the enter button 10 is pressed after the URL is input, the data representing the entered URL, a web page request and identification data identifying the model of mobile telephone 1 are transmitted to the relay server 40 (step 61 in FIG. 10).

The URL data, web page request and identification data transmitted from the mobile telephone 1 are received by the relay server 40 (step 81 in FIG. 10), whereupon the model of the mobile telephone 1 is determined from the identification data (step 82 in FIG. 10). When the data representing the URL is transmitted from the mobile telephone 1 to the relay server 40, data referred to as a “user agent” is transmitted from the mobile telephone 1 to the relay server 40. Since the user agent contains data identifying the mobile telephone 1, the model of the mobile telephone 1 can be verified utilizing the identification data contained in the user agent.

When the model of the mobile telephone 1 is determined, a second browser corresponding to the determined model is read from the browser management unit 43 (step 83 in FIG. 10). As described above, the second browser read from the browser management unit 43 is such that the keypad buttons are assigned functions identical with the functions that have been assigned to the buttons in a case where the first browser already installed in the mobile telephone 1 is run. The user of the mobile telephone 1 thus can operate the second browser using buttons the same as those pressed when the first browser is operated. The second browser that has been read from the browser management unit 43 is transmitted from the relay server 40 to the mobile telephone 1 (step 84 in FIG. 10).

When the second browser transmitted from the relay server 40 is received by the mobile telephone 1 (step 62 in FIG. 10), the second browser is launched after it is installed in the mobile telephone 1 (step 63 in FIG. 10). The mobile telephone 1 operates in accordance with the second browser after the second browser is launched. The first browser may or may not be terminated.

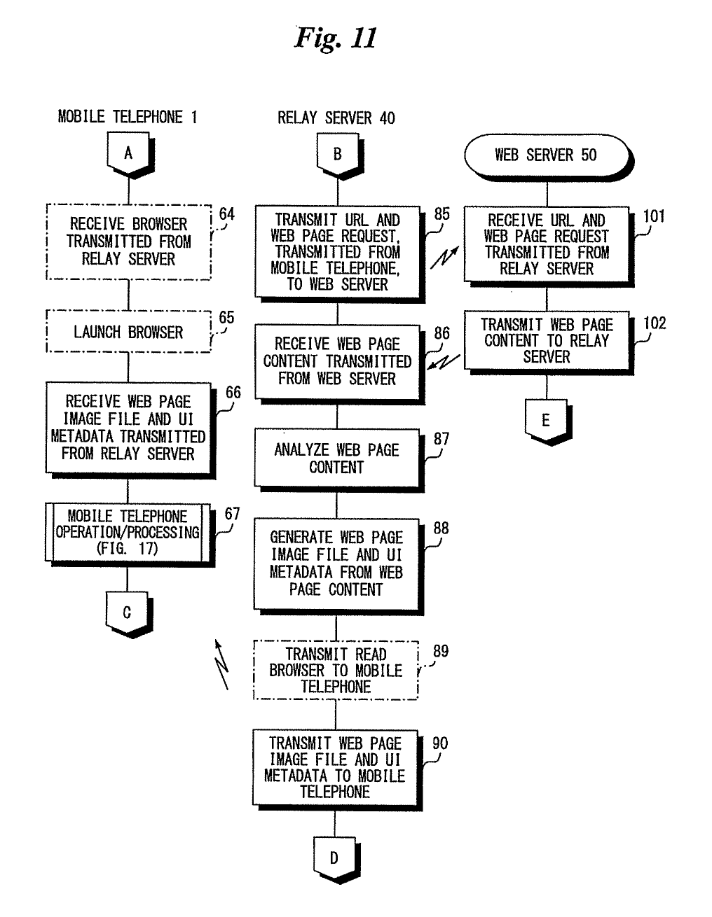

The URL data and the web page request that have been transmitted from the mobile telephone 1 are transmitted from the relay server 40 to the web server 50 (step 85 in FIG. 11).

When the URL data and web browser request transmitted from the relay server 40 are received by the web server 50 (step 101 in FIG. 11), a web content file that has been stored at the storage location of the URL specified by the received URL data is read from the storage unit 53. The read web content file is transmitted from the web server 50 to the relay server 40 (step 102 in FIG. 11).

The web content file transmitted from the web server 50 is received by the relay server 40 (step 86 in FIG. 11). The received web content file is analyzed and the UI information extracted by the UI information analyzing unit 45 (step 87 in FIG. 11). The method of analyzing the web content file is not particularly limited and use may be made of a well-known method of parsing an HTML (HyperText Markup Language) file, which is contained in the web content file, and extracting tags.

Next, the relay server 40 generates an image file for displaying a web page image in which the web page represented by the web page content file is represented as one frame of an image (step 88 in FIG. 11). It is possible to generate this image file by executing processing in the image converting unit 44 for converting the web content file to an image file. Further, the UI information analyzing unit 45 generates UI metadata based upon the result of analysis (step 88 in FIG. 11).

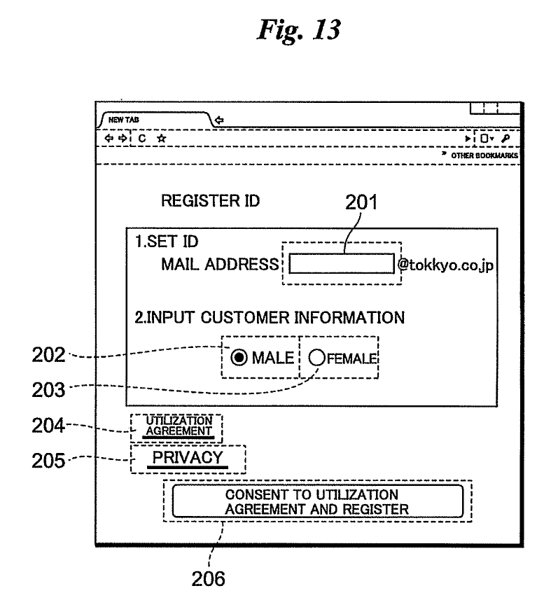

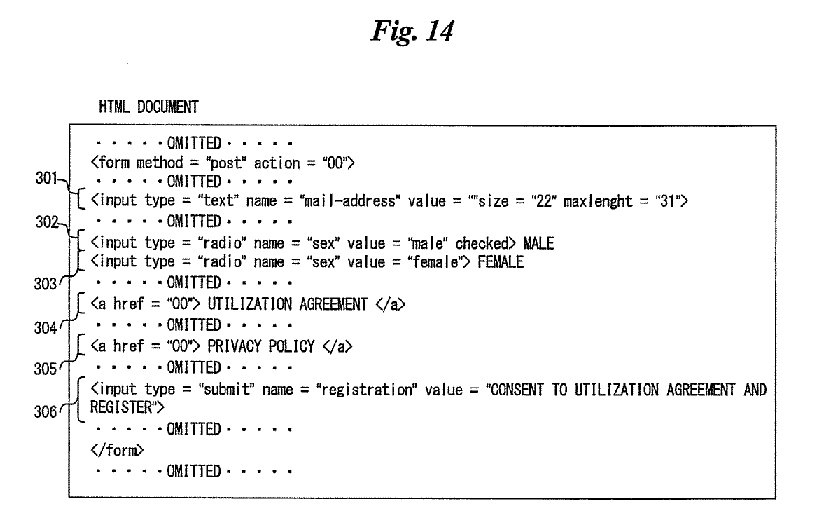

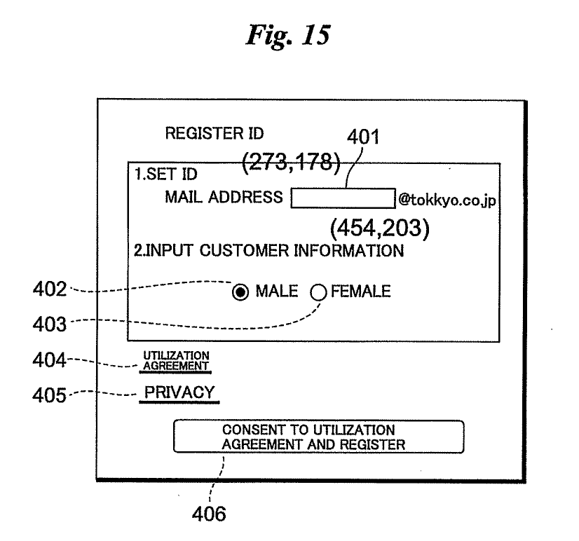

FIGS. 13 to 15 are useful in describing the generation of UI metadata. FIG. 13 illustrates a web page in which an HTML file shown in FIG. 14 has been browsed using an ordinary personal computer. FIG. 14 is an example of an HTML document described by the HTML file. FIG. 15 is a web page image representing the web page as one frame of an image.

With reference to FIG. 13, the web page is an ID registration page. The web page contains an ID setting section that includes a character string “SET ID” and a customer information input section that includes a character string “ENTER CUSTOMER INFORMATION”. The ID setting section includes a text input field 201, and the customer information input section includes radio buttons 202 and 203. The web page is further formed to include a clickable area 204 composed of a character string reading “UTILIZATION AGREEMENT”, a clickable area 205 composed of a character string reading “PRIVACY”, and a clickable area 206 composed of a character string reading “CONSENT TO UTILIZATION AGREEMENT AND REGISTER”.

The UI information analyzing unit 45 extracts UI information such as link tags and input forms from the HTML document shown in FIG. 14 and calculates the coordinate position of each item of UI information on the web page of FIG. 15. For example, a text input section tag 301, a radio button tag 302, a radio button tag 303, a link tag 304, a link tag 305 and a button tag 306 have been described in the HTML document shown in FIG. 14. The web page text input field 201, radio buttons 202 and 203 and the clickable areas 204, 205 and 206 are formed by the text input section tag 301, radio button tag 302, radio button tag 303, link tag 304, link tag 305 and button tag 306, respectively.

The UI information analyzing unit 45 extracts the UI information 201 to 206 by extracting the tags 301 to 306 from the HTML document. Further, the UI information analyzing unit 45 acquires the XY coordinate values (coordinate values corresponding to the upper left and lower right) of the beginning and end of each item of this UI information. The method of acquiring the coordinate values is not particularly limited. For example, a method of storing the coordinate values during image rendering and then acquiring the values from a browser may be used.

Each item of the UI information thus extracted and the position information of each item are correlated together with the respective UI information ID and are stored in a storage unit (not shown) of the relay server 40 as UI metadata. Here it is assumed that the UI information ID uses the symbols 201 to 206 identical with those of the respective items of UI information.

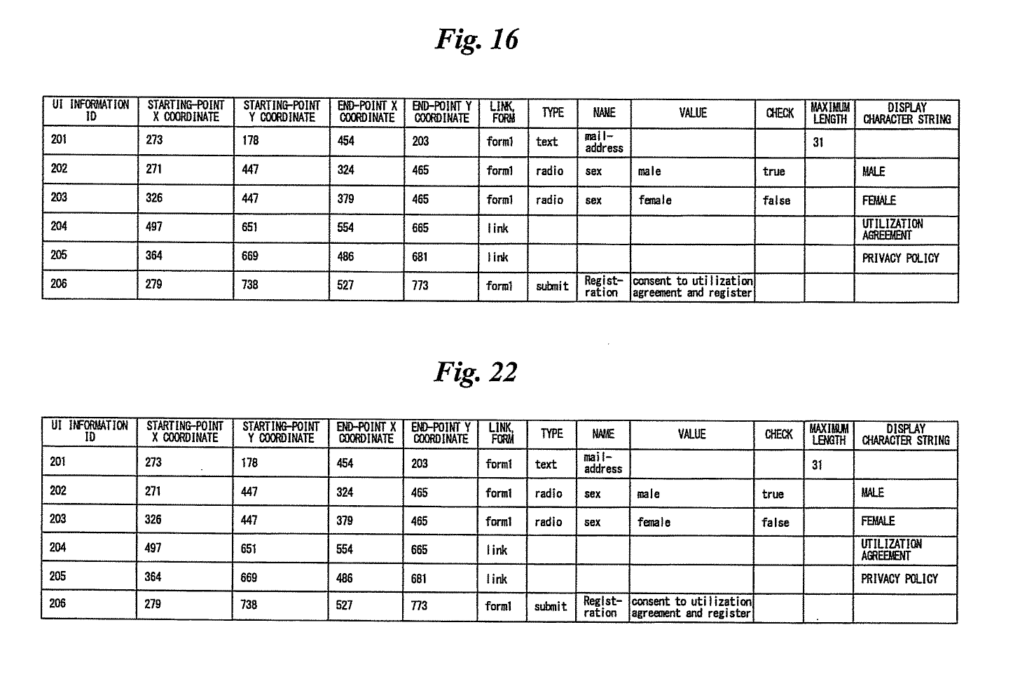

FIG. 16 is an example of UI metadata that has been stored.

For every item of UI information specified by a UI information ID, the UI metadata contains a starting-point X coordinate, starting-point Y coordinate, end-point X coordinate and end-point Y coordinate of the UI information; information indicating whether the UI information is a link or form; the type of UI information; the name of the UI information; the value of the UI information; a check of UI information; the maximum value of UI information; and a display character string.

As shown in FIG. 15, the web page image has a composition similar to that of the web page illustrated in FIG. 13.

In a manner similar to the web page shown in FIG. 13, the web page image shown in FIG. 15 includes the character string “SET ID”, the character string “ENTER CUSTOMER INFORMATION”, the character string “UTILIZATION AGREEMENT”, the character string “PRIVACY” and the character string “CONSENT TO UTILIZATION AGREEMENT AND REGISTER”. In a manner similar to the web page shown in FIG. 13, the web page image shown in FIG. 15 is formed to have a text area 401 corresponding to the text input field 201, check areas 402 and 403 corresponding to the radio buttons 202 and 203, respectively, and character string areas 404, 405 and 406 corresponding to the clickable areas 204, 205 and 206, respectively. However, the web page image illustrated in FIG. 15 differs from the web page shown in FIG. 13 in that text cannot be input directly to the web page image and the web page image cannot be clicked.

With reference again to FIG. 11, it may be so arranged that the second browser is transmitted from the relay server 40 to the mobile telephone 1 after the web page image file and UI metadata are generated (step 89 in FIG. 11). When the second browser transmitted from the relay server 40 is received by the mobile telephone 1 (step 64 in FIG. 11), the second browser is launched in the mobile telephone 1 (step 65 in FIG. 11).

The relay server 40 transmits the generated UI metadata and image file to the mobile telephone 1 (step 90 in FIG. 11). The web page content file is stored in the relay server 40 in the storage device in correlation with the mobile telephone 1 to which the transmission was made and the generated UI metadata.

The mobile telephone 1 receives the UI metadata and image file transmitted from the relay server 40 (step 67 in FIG. 11). Upon receiving the UI metadata and image file, the mobile telephone 1 displays the web page image, which is represented by the received image file, on the display screen 3. While viewing the web page image displayed on the display screen 3, the user operates the keypad (mobile telephone operation/processing; step 67 in FIG. 11). The details of the mobile telephone operation/processing will be described later.

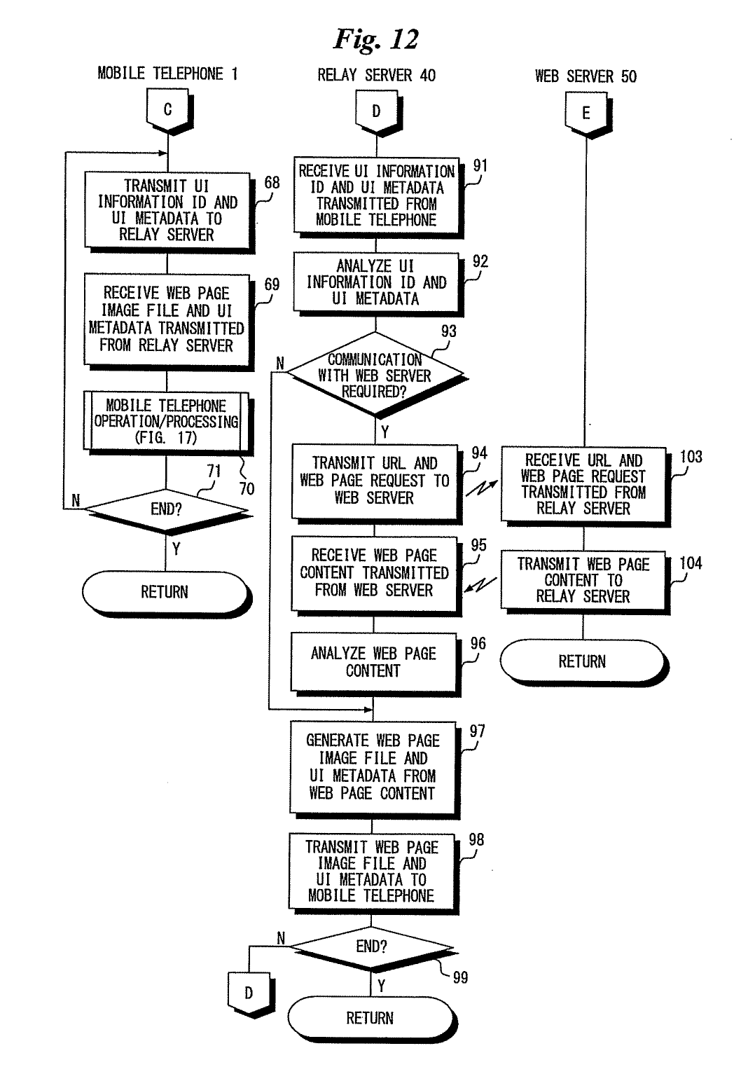

In accordance with the operation of the mobile telephone 1, the UI metadata is rewritten and the UI information ID and rewritten UI data are transmitted from the mobile telephone 1 to the relay server 40 (step 68 in FIG. 12).

The UI metadata and UI information ID transmitted from the mobile telephone 1 are received by the relay server 40 (step 91 in FIG. 12).

The UI information analyzing unit 45 analyzes the received UI metadata and executed UI information ID and performs analysis to determine which UI information in the UI metadata was executed (step 92 in FIG. 12). Further, based upon the executed UI information, the UI information analyzing unit 45 determines whether communication with the web server 50 is necessary (step 93 in FIG. 12). For example, if a link button is clicked and the screen is to transition from one screen to another, then it is determined that communication with the web server 50 is necessary.

In a case where the UI information that has been executed is UI information requiring communication with the web server 50 (“YES” at step 93 in FIG. 12), the relay server 40 acquires the URL of the transition destination from the web page content that has been stored in the storage unit of the relay server 40 and transmits data representing the acquired URL and a web page request to the applicable web server 50 (step 94 in FIG. 12).

Upon receiving the URL data and web page request transmitted from the relay server 40 (step 103 in FIG. 12), the web server 50 reads out the web page content file that has been stored at the URL specified by this URL data. The web page content file read out is transmitted from the web server 50 to the relay server 40 (step 104 in FIG. 12).

When the web page content file transmitted from the web server 50 is received by the relay server 40 (step 95 in FIG. 12), the web page content file is analyzed in the UI information analyzing unit 45 (step 96 in FIG. 12).

The UI information analyzing unit 45 generates the UI metadata of the transition destination based upon the result of analysis, and the image converting unit 44 generates an image file from the web page content file at the transition destination (step 97 in FIG. 12). The generated image file and UI metadata are transmitted from the relay server 40 to the mobile telephone 1 (step 98 in FIG. 12). If this processing is not exited, then the processing from step 91 onward is repeated (step 99 in FIG. 12).

The mobile telephone 1 receives the image file and UI metadata transmitted from the relay server 40 (step 69 in FIG. 12) and displays the web page image represented by the image file on the display screen 3 as the screen of the transition destination. The mobile telephone is operated using the web page image displayed (step 70 in FIG. 12). If this processing is not exited, then the processing from step 68 onward is repeated (step 71 in FIG. 12).

If it is determined that the UI information executed in the mobile telephone 1 is UI information not requiring communication with the web server 50 (“NO” at step 93 in FIG. 12), then control proceeds to step 97. The web page content file related to the rewritten UI metadata is read out of the storage unit of relay server 40 and a new image file is generated based upon the rewritten UI metadata (step 97 in FIG. 12). Rather than generate a new image file, rewriting may be performed only with regard to the portion of the web page image that requires rewriting.

The new image file and the UI metadata are transmitted from the relay server 40 to the mobile telephone 1 (step 98 in FIG. 12).

The mobile telephone 1 receives the image file and UI metadata transmitted from the relay server 40 (step 69 in FIG. 12) and displays the web page image represented by the image file on the display screen 3. The mobile telephone is operated using the web page image displayed (step 70 in FIG. 12).

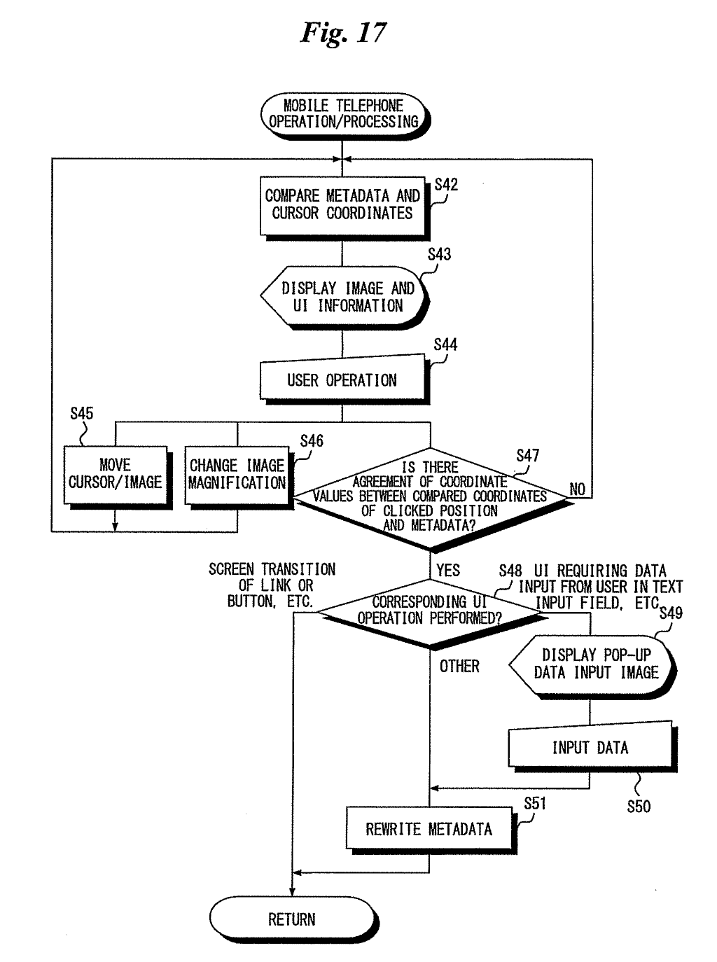

FIG. 17 is a flowchart illustrating processing (the processing of step 67 in FIG. 11 and the processing of step 70 in FIG. 12) executed in the mobile telephone 1 using the image file and UI metadata transmitted from the relay server 40.

Upon receiving the UI metadata and image file, the mobile telephone 1 uses the processing unit 30 to compare the position coordinates of each item of UI information contained in the UI metadata and a cursor (or simple frame) displayed on the display screen 3 (step S42). The image file and UI information are displayed on the display screen 3 based upon the result of comparison.

For example, when the position coordinates of the cursor overlap the position coordinates of UI information, a mark is appended to the portion at the position of the applicable UI information and the user is made aware of the fact that the UI information is selectable. Further, the portion may be underlined or enclosed by a square. If the cursor is situated within a rectangular zone in which the XY coordinates of each item of UI information recorded in the UI metadata are adopted as the diagonal, then the position coordinates of the UI information and the position coordinates of the cursor are regarded as overlapping. Further, rather than in a case where there is overlap, such a display may be performed at all times with respect to the position of the displayed UI information on the image. Conversely, the cursor may be displayed upon changing the color or shape thereof when the cursor position coordinates overlap the position coordinates of the UI information.

When the user performs an operation using the keypad 6 (step S44), the display on the display screen 3 changes in accordance with the operation performed. For example, in a case where an up, down, left, right movement operation is performed using the button 11, the cursor is moved in accordance with this operation (step S45). Since the operation of the keypad 6 is the same as that in a case where use is made of the first browser that has been installed in the mobile telephone 1, the user will not be confused even if the user utilizes the second browser.

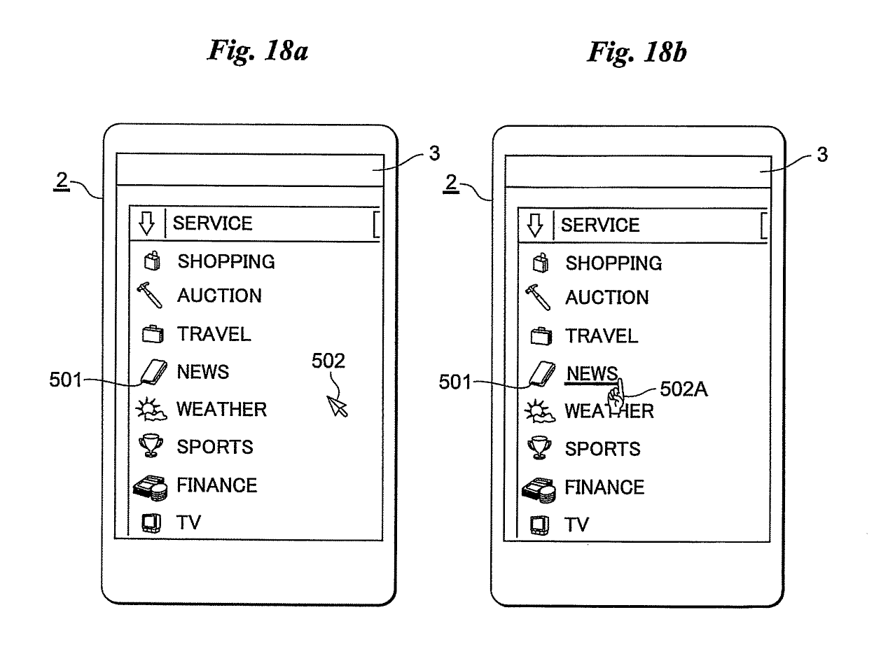

FIGS. 18a and 18b illustrate a case where a cursor moves on a web page image in accordance the operation.

In FIG. 18a, a cursor 502 is being displayed on the right side of the display screen 3 substantially at the center thereof. FIG. 18b illustrates a web page image in a case where an operation for moving the cursor 502 to the upper left from the state shown in FIG. 18a has been performed. When the cursor 502 is moved to a position 501 (a link in this instance) of UI information at the upper left of the screen in accordance with user operation, the position 501 of the UI information is underlined and the arrow shape of the cursor 502 is displayed upon being changed to a hand-shaped cursor 502A.

It should be noted that by performing an operation using the enter button under these conditions, a link destination related to the position 501 of the UI information can be displayed, as will be described later.

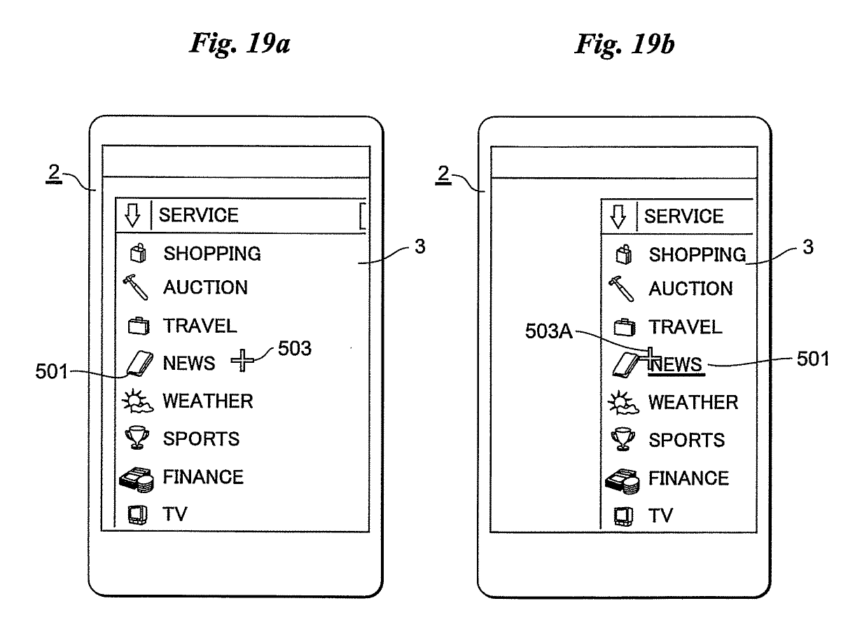

FIGS. 19a and 19b illustrate a case where it is so arranged that an image moves in accordance with operation when an up, down, left, right movement operation is performed in similar fashion.

FIG. 19b illustrates a case where an operation for movement to the right from the state of FIG. 19a has been performed. A cursor 503 is displayed while stationary at the center of the screen of display unit 34, and the image being displayed is moved in accordance with user operation. If the position 501 of the UI information on the image is moved onto the cursor 503, the position 501 of the UI information on the image is underlined and the cursor 503 is displayed upon changing to a cursor 503A of a different color.

Further, in a case where a size reducing/enlarging operation has been performed at step S44, the image is displayed upon being changed to a magnification conforming to the operation.

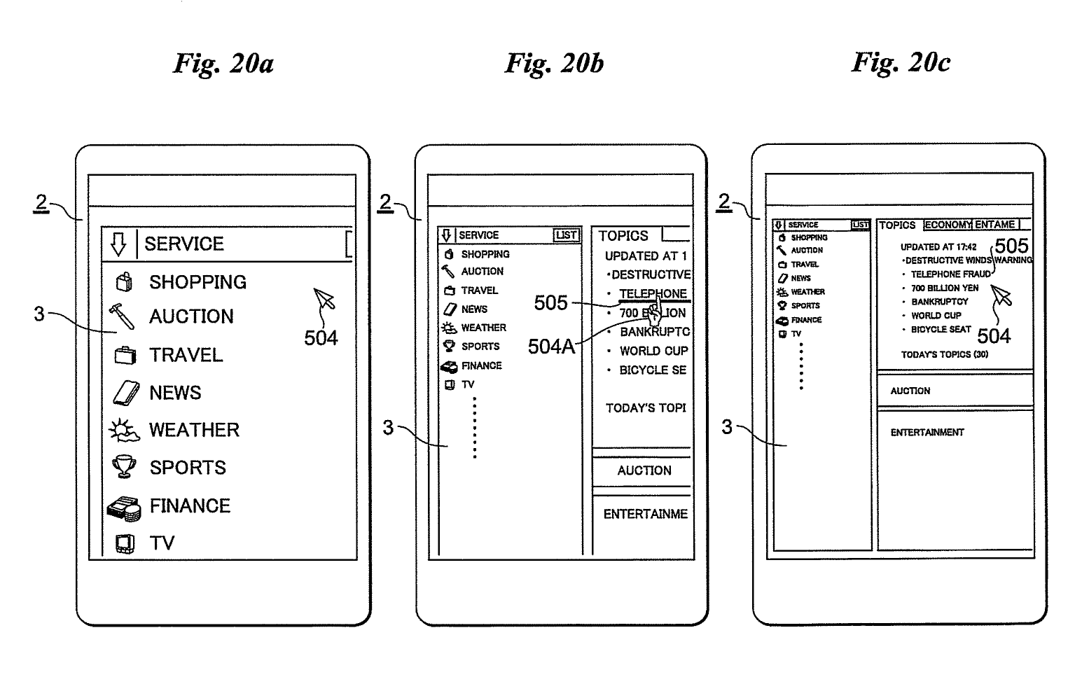

FIGS. 20a to 20c are examples of web page images displayed on the display screen 3 in a case where a size reducing/enlarging operation has been performed.

If a reducing operation is performed from the state shown in FIG. 20a, the image is reduced in size and displayed as shown in FIG. 20b. It is possible to display an image as shown in FIG. 20c by performing a further reducing operation.

If an enlarging operation is performed from the state shown in FIG. 20c, the image is enlarged in size from FIG. 20c and displayed as shown in FIG. 20b. It is possible to display the image as shown in FIG. 20a by performing a further enlarging operation.

It should be noted that the position of cursor 504 on the screen in FIGS. 20a to 20c is unchanged. However, since the display magnification of the displayed image is changed about a center position other than the display position of the cursor 504, the position of the cursor 504 on the image shifts.

As a result of the foregoing, the position of the cursor 504 in the state shown in FIG. 20a does not overlap the position of UI information on the image. In the state shown in FIG. 20b, however, position 505 of UI information (a link) on the image and the position of the cursor 504 do overlap. Accordingly, the position 505 of the UI information on the image is underlined and the shape of cursor 504 is changed to cursor 504A and displayed as cursor 504A.

Further, in a case where an operation (a clicking operation) using the enter button has been performed at step S44, whether the cursor position and position of UI information on the image overlap is determined based upon the result of the comparison performed at step S42 (step S47).

If the cursor position does not overlap the position of UI information on the image, then the processing unit 30 invalidates the clicking operation, returns control to step S42 and executes similar processing.

If the cursor position overlaps the position of UI information on the image, then, based upon the UI metadata, the processing unit 30 discriminates the type of UI information at the position of overlap with the cursor position (step S48).

Three types of UI information are conceivable, namely UI information, such as an input in the text input field, requiring a user input; UI information, such as a check box or radio button, not accompanied by a screen transition and not requiring a data input; and UI information, such as a link or button, accompanied by a screen transition.

If the type of UI information present at the cursor position is found to be UI information, such as an input in the text input field, requiring a user input, first a data input screen is displayed on the display screen 3 as by a pop-up and the user is requested to perform the input (step S49). The user performs the required data input on this input screen using the keypad 6 (step S50). In accordance with the input, the processing unit 30 rewrites the UI metadata that has been stored in the memory 32 (step S51). The rewritten UI metadata is transmitted together with the rewritten UI information ID to the relay server 40 via the communication circuit 31 (step S52).

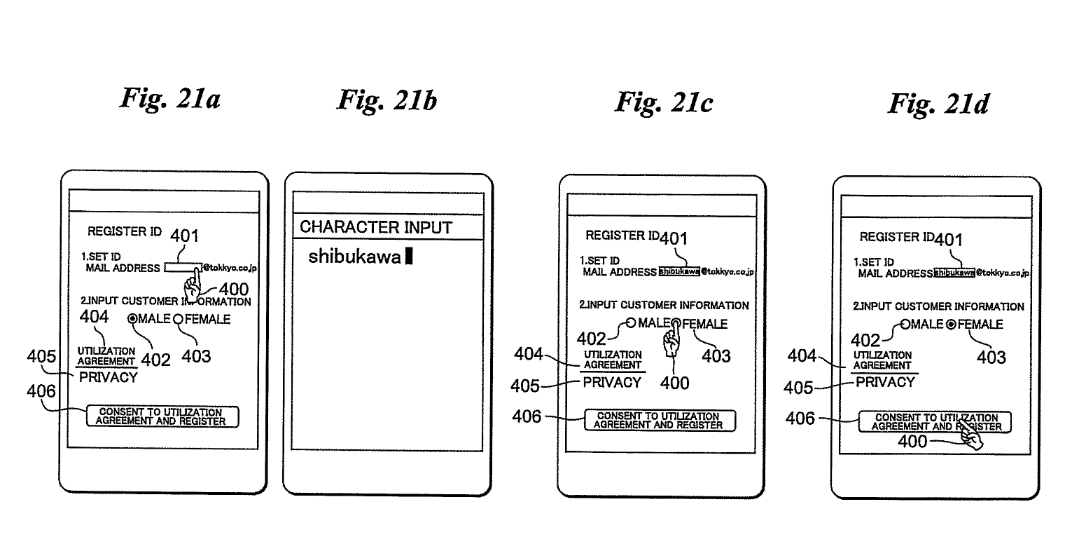

The details regarding rewriting of UI metadata will be described with reference to FIGS. 21a to 21d and FIGS. 22 to 24.

FIGS. 21a to 21d show examples of web page images being displayed on the display screen of the mobile telephone 1, and FIGS. 22 to 24 show examples of UI metadata.

In FIG. 21a, the web page image shown in FIG. 15 is being displayed on the display screen 3. The items of UI information 201 to 206 are being displayed at the respective positions 401 to 406 on the display image, as indicated in the UI metadata shown in FIG. 22. If the user moves cursor 400 onto position 401 corresponding to the text input field 201 and performs a clicking operation, then a text-input pop-up image will be displayed on the display screen 3, as illustrated in FIG. 21b.

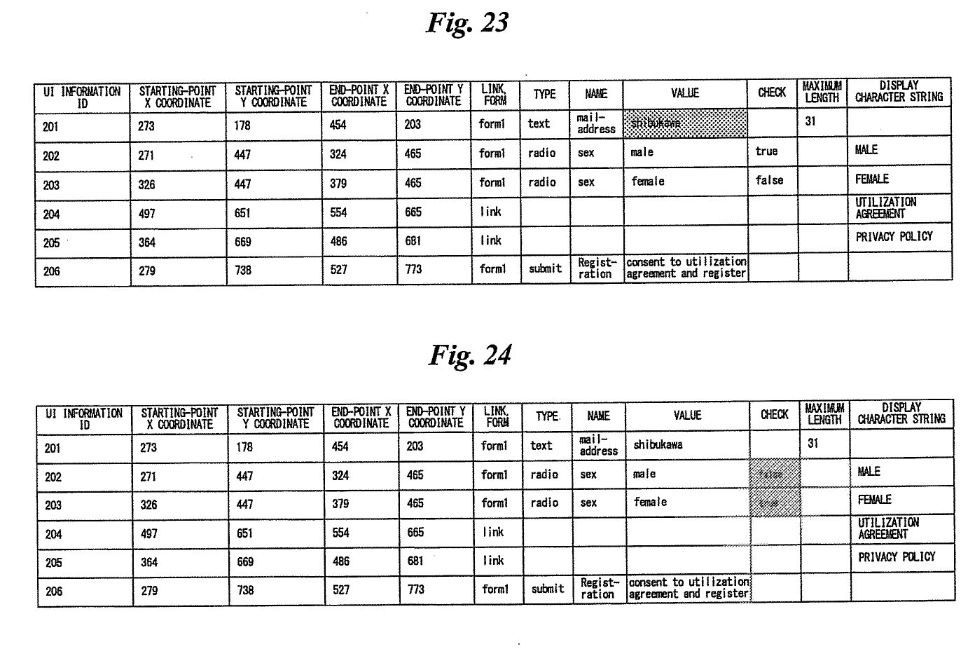

The user inputs the desired characters on this pop-up image using the keypad 6. If the user performs a clicking operation using the keypad 6 after inputting the text, the processing unit 30 rewrites the value of the UI information 201 corresponding to position 401 based upon the text that has been input. Since the user has input “shibukawa” on the text-input pop-up screen, as shown in FIG. 21b, the value of UI information 201 has been rewritten to “shibukawa” as shown in FIG. 23.

The rewritten UI metadata is transmitted from the mobile telephone 1 to the relay server 40 together with the rewritten (executed) UI information ID (here 201).

Next, the case where the corresponding UI information is UI information not accompanied by a screen transition and not requiring a data input will be described.

Radio buttons for designating sex are being displayed at position 402 corresponding to UI information 202 and position 403 corresponding to UI information 203 shown in FIG. 21. The items of UI information 202 and UI information 203 have name attributes whose basic tags 302 and 303 are identical, as shown in FIG. 14. That is, it is possible to select either one of UI information 202 or UI information 203. In this initial setting, the check attribute of UI information 202 is “true” and the check attribute of UI information 203 is “false”, as illustrated in FIG. 22. As shown in FIG. 21a, therefore, the prevailing state is such that UI information 202 has been selected.

Accordingly, if cursor 400 is moved onto the position 403 corresponding to UI information 203 and a clicking operation is performed, then, based upon the UI metadata, the processing unit 30 discriminates the type of UI information that exists at the position of overlap with the cursor position.

Here the UI information 203 is a radio button, which is UI information that does not require a data input from the user and is not accompanied by a screen transition. Control therefore proceeds to step S51 and the processing unit 30 rewrites the UI data that has been stored in memory 32 to data relating to the UI information 203.

FIG. 24 is a diagram illustrating the rewritten UI metadata in this case. The check attribute of UI information 203 has been rewritten to “true” and the name attribute of UI information 202 having the same name attribute as that of the UI information 203 has been rewritten to “false”.

A case where the corresponding UI information is accompanied by a screen transition will be described. UI information accompanied by a screen transition refers to UI information which, as a result of this UI information being executed, displays an image different from the image currently being displayed.

As shown in FIG. 21d, what is being displayed at position 406 corresponding to UI information 206 is a transmit button. Clicking the position 406 causes a transition to another screen in accordance with the content of the tag 306. If the cursor 400 is moved over position 406 and a clicking operation performed, then, based upon the UI metadata, the processing unit 30 discriminates the type of UI information that exists at the position of overlap with the cursor position.

Here, since the UI information 206 is a button and is accompanied by a screen transition, control proceeds to step S68 (FIG. 12). The executed UI information ID (206 in this case) is transmitted together with the UI metadata to the relay server 40 via the communication circuit 31 (step S68).

Thus, regardless of which type of UI information is clicked, the UI metadata and the executed UI information ID are transmitted to the relay server 40.

For example, in a case where the executed UI information is the UI information 201 (text input field) illustrated in FIG. 21a, rewritten UI metadata shown in FIG. 23 and the executed UI information ID 201 are transmitted from the mobile telephone 1 to the relay server 40.

The relay server 40 reads the content file relating to the rewritten UI metadata out of a storage unit (not shown) and generates a new image file based upon the rewritten UI metadata. The new image file becomes an image in which the characters “shibukawa”, which were input at step S50, are displayed at the position of the text input field, as shown in FIG. 21c.

Further, in a case where the executed UI information is the UI information 203 (radio button) shown in FIG. 21c, rewritten UI metadata shown in FIG. 24 and the executed UI information ID 203 are transmitted from the mobile telephone 1 (step 61).

The relay server 40 reads the web page content file relating to the rewritten UI metadata out of a storage unit and generates a new image file based upon the rewritten UI metadata. The new image file becomes an image in which the checked position of the radio button has been changed from position 402 to position 403, as shown in FIG. 21d.

Further, in a case where the executed UI information is the UI information 206 (button) shown in FIG. 21d, UI metadata (which has not been rewritten in this case) and the executed UI information ID 206 are transmitted from the mobile telephone 1 (step 61). The relay server 40 receives the data and ID via the communication circuit 41 (step S71).

The relay server 40 that has received the data and ID acquires the URL address of the transition destination from the UI metadata, requests the applicable web page content file from the web server 50 (step S85) and receives the content file (step S86). On the basis of this content file, UI metadata is generated in the UI information analyzing unit 45 and an image file is generated in the image converting unit 44 (step S88).

The image file at the transition destination and the UI metadata are transmitted to the mobile telephone 1 (step S89) and the web page image represented by the image file is displayed on the display screen 3.

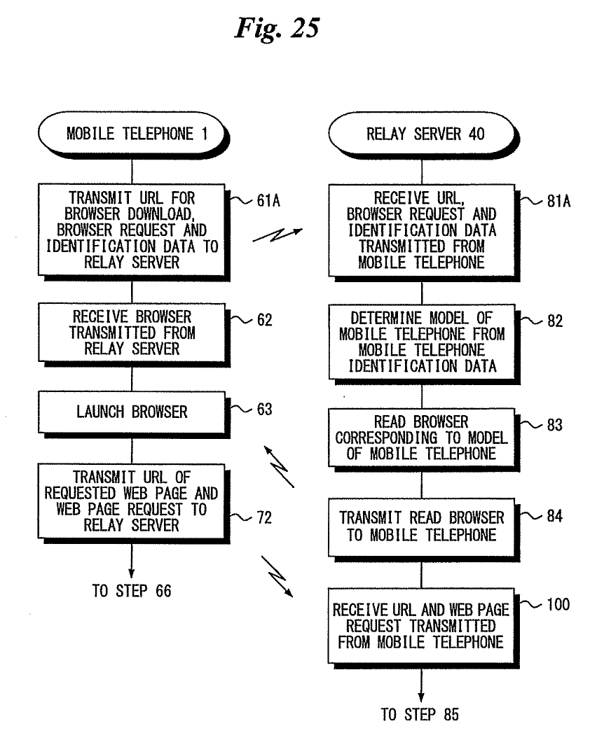

FIG. 25 is a flowchart illustrating processing executed by the mobile telephone 1 and relay server 40 according to a modification. Processing steps in FIG. 25 identical with those shown in FIG. 10 are designated by like step numbers and need not be described again.

In this modification, an URL requesting a second browser has been predetermined. By accessing the URL, the second browser is transmitted from the relay server 40 to the mobile telephone 1.

Data representing the URL for downloading the second browser, a browser request and data identifying the model of mobile telephone 1 are transmitted from the mobile telephone 1 to the relay server 40 (step 61A).

Upon receiving the URL data, browser request and identification data transmitted from the mobile telephone 1 (step 81A), the relay server 40 verifies the model of the mobile telephone 1 (step 82). The second browser conforming to the verified model of the mobile telephone 1 is read out and transmitted from the relay server 40 to the mobile telephone in the manner described above (steps 83, 84).

When the second browser transmitted from the relay server 40 is received by the mobile telephone 1 (step 62), the second browser is launched (step 63). Data representing the URL of the web page to be viewed and the web page request are transmitted from the mobile telephone 1 to the relay server 40 by utilizing the launched second browser (step 72).

When the URL data and web page request transmitted from the mobile telephone 1 are received by the relay server 40 (step 100), the URL data and web page request are transmitted from the relay server 40 to the web server 50. The web content file is transmitted from the web server 50 to the relay server 40 and the web page image is displayed on the mobile telephone 1 in the manner described above.

As many apparently widely different embodiments of the present invention can be made without departing from the spirit and scope thereof, it is to be understood that the invention is not limited to the specific embodiments thereof except as defined in the appended claims.

What is claimed is:

1. A web browser transmission server, comprising:
a model data receiving device for receiving model data, which specifies the model of a mobile telephone, transmitted from the mobile telephone in which a first web browser has been installed;
a web browser reading device for reading a second web browser, which corresponds to the model specified by the model data received by said model data receiving device, from a storage device in which a number of second web browsers have been stored in correspondence with mobile-telephone models, these second web browsers being such that commands thereof assigned to the keypad of the mobile telephone will be identical with commands of the first web browser that have been assigned to the keypad of the mobile telephone; and
a web browser transmitting device for transmitting the second web browser, which has been read by said web browser reading device, to the mobile telephone that transmitted the model data.

2. The server according to claim 1, further comprising:
a web page request receiving device for receiving a web page request transmitted from a mobile telephone;
a web page request transmitting device for transmitting the web page request, which has been received by said web page request receiving device, to a web page server storing web page content representing a web page requested by this web page request;
a web page content receiving device for receiving the web page content transmitted from the web page server in response to transmission of the web page request to the web server by said web page request transmitting device;
a first image file generating device for generating an image file representing, as an image, the web page represented by the web page content received by said web page content receiving device;
a user interface metadata generating device for generating user interface metadata from user interface information, which is included in the web page content received by said web page content receiving device and represents a user interface area that accepts an input or check from a user on the web page, the user interface metadata representing a coordinate position of the user interface area on the web page as well as the details of the input or check in the user interface area;
a first image file/user interface metadata transmitting device for transmitting the image file generated by said first image file generating device and the user interface metadata generated by said user interface metadata generating device to the mobile telephone that transmitted the web page request;
a user interface metadata receiving device, responsive to transmission by said first image file/user interface metadata transmitting device of the image file and user interface metadata to the mobile telephone that transmitted the web page request, for receiving the user interface metadata transmitted from the mobile telephone;
a second image file generating device for generating an image file representing, as an image, a web page having contents in which the user interface area is represented by the user interface metadata that has been received by said user interface metadata receiving device; and
a second image file/user interface metadata transmitting device for transmitting the user interface metadata received by said user interface metadata receiving device and the image file generated by said second image file generating device to the mobile telephone that transmitted the user interface metadata;
wherein the second web browser displays an image, which is represented by the image files that have been transmitted from the first image file/user interface metadata transmitting device and from the second image file/user interface metadata transmitting device, on a display screen of the mobile telephone, rewrites the user interface metadata, which has been transmitted from the first image file/user interface metadata transmitting device and from the second image file/user interface metadata transmitting device, in accordance with an input or check from the keypad of the mobile telephone, and transmits the rewritten user interface metadata to the web browser transmission server.

3. A method of controlling operation of a web browser transmission server, comprising the steps of:
specifying the model of a mobile telephone transmitted from a mobile telephone in which a first web browser has been installed;
reading a second web browser, which corresponds to the model specified by the model data received, from a storage device in which a number of second web browsers have been stored in correspondence with mobile-telephone models, these second web browsers being such that commands thereof assigned to the keypad of the mobile telephone will be identical with commands of the first web browser that have been assigned to the keypad of the mobile telephone; and
transmitting the read second web browser to the mobile telephone that transmitted the model data.
